(19) United States
(12) Patent Application Publication
(10) Pub. No.: US 2011/0136535 A1
(43) Pub. Date: Jun. 9, 2011

(54) Appartus for Communication Privacy and Fidelity

(75) Inventors: Richard J. DiPasquale, Derry, NH (US); Donald A. Mathieu, Danville, NH (US); Robert C. Brockway, Salem, NH (US)

(73) Assignee: Alcatel-Lucent USA Inc., Murray Hill, NJ (US)

(21) Appl. No.: 12/652,459

(22) Filed: Jan. 5, 2010

Related U.S. Application Data
(60) Provisional application No. 61/266,778, filed on Dec. 4, 2009.

(51) Int. Cl. H04W 88/02

(52) U.S. Cl. 455/550.1

(57) ABSTRACT

An accessory device for enhancing privacy and sound fidelity when using a mobile communication instrument such as a cell phone or hands-free headset. The apparatus of the accessory device includes an acoustic tunnel forming a first opening at a first end and a second opening at a second end, the first opening for receiving at least a portion of the communication instrument and the second opening for placing in the vicinity of a sound source. A constraining device may be employed to retain the communication instrument in place in the first opening.

### CROSS-REFERENCE TO RELATED APPLICATIONS

The present disclosure is related to and claims priority from U.S. Provisional Patent Application Ser. No. 61/266,778, entitled Device for Communication Privacy and Fidelity, filed on Dec. 4, 2009, the entire contents of which are incorporated by reference herein.

### TECHNICAL FIELD

The present invention relates generally to the field of mobile communications, and, more particularly, to an apparatus for enhancing privacy and sound fidelity for users of mobile communication instruments such as mobile phones and the hands-free headsets that are often associated with cell phones.

### BACKGROUND

Mobile communication instruments are now in widespread use. In the not-too-distant past, devices such as mobile phones were expensive and available to only the few who could afford them. In addition, such devices were large and bulky and somewhat inconvenient to use. Wireless networks for their use were incomplete and there were broad gaps in coverage. Presently, however, technological advances have made such devices not only more affordable, but smaller and easier to carry around. Service is available in most areas of the United States, and in fact in much of the world. A majority of the adults in this country now own and frequently use mobile phones and similar devices, as do many young adults and even children as well.

As a result, there are now a great many telephone conversations taking place in public places. The phone booth is becoming something of an anachronism, and many people within a relatively-small area may be engaged in their own telephone calls, talking with distant parties. At times, this can create an annoying atmosphere for others who are present, especially in confined areas such as restaurants and airplane cabins. The problem is exacerbated by the fact that mobile phone users have a tendency to speak more loudly than those engaged in normal conversation with others who are in the same area. This may be habitual, but is often due to the fact that the user of a mobile phone may have a hard time being heard and understood by the other party, and may have a hard time hearing the conversation themselves.

In addition, due to emphasis on aesthetics and convenience rather than sound quality, many phone manufacturers design mobile phones and headsets with sub-optimal microphone placement. As a result, mobile phones and hands-free headsets often do not provide the optimum placement of the microphone to allow users to speak in low voices to improve privacy and improve courtesy by lessening the disturbance to others, especially in crowded or noisy environments. For these reasons the privacy of mobile-phone conversations is often severely compromised.

To cope with this inadequacy, sometimes users try to awkwardly cup their hands or contort their bodies to try in an effort to gain some privacy for their conversation, to enable themselves to be more clearly understood, or simply as a courtesy to others in the immediate area. This of course may negatively impact their comfort and their ability to perform other tasks, for example taking or referring to notes, while engaged in a conversation.

Accordingly, there has been and still is a need to address the aforementioned shortcomings and other shortcomings associated with communicating on a mobile communications instrument. These needs and other needs are satisfied by the present invention.

### SUMMARY

The present invention is directed to an apparatus for use as an accessory for a portable communication instrument. The apparatus includes an acoustic tunnel forming a first opening at a first end and a second opening at a second end, the first opening for receiving at least a portion of the communication instrument and the second opening for placing in the vicinity of a sound source. The acoustic tunnel may be integrally-formed or include acoustic sub-tunnels configurable to form the acoustic tunnel. The acoustic tunnel is preferably adjustable in shape, and may include circumferential or longitudinal stiffening elements to help maintain a desired shape. The acoustic tunnel preferably collapses to a relatively-flat shape for storage when not in use, and in some embodiments may also function as a carrying case for the communication instrument when it is not in use.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is an isometric view of a privacy apparatus used in conjunction with a mobile communication instrument according to an embodiment of the present invention;

FIG. 2 is a side view of a privacy apparatus according to another embodiment of the present invention;

FIG. 3 is an isometric view of the privacy apparatus of FIG. 2 in an extended configuration;

FIG. 4 is an isometric view of the privacy apparatus of FIG. 2 in a collapsed configuration; and

FIG. 5 is an isometric view of the privacy apparatus of FIG. 2 in a collapsed configuration.

### DETAILED DESCRIPTION

The present invention is directed to an apparatus to be used in cooperation with a mobile electronic communication instrument. This communication instrument may be, for example, a mobile telephone (sometimes referred to simply as a cell phone). This category of instrument is meant to include such feature-rich variations as the Blackberry®, iPhone, and similar devices. Note, however, that the communication instrument is not a required element of the invention unless explicitly claimed as such in a particular embodiment.

Modern cell phones are typically small, being only a few inches or less in both width and length and having a flat profile (see for example the communication instrument shown in FIG. 1). A speaker for listening is located near one end, and positioned so that it may be held adjacent to the ear of the user. A microphone for picking up sounds, normally the voice of the user, is located near an opposite end, so that it is relatively closer to the user's mouth when the speaker is positioned near the ear. As used herein, the dimension extending between these two ends will be referred to as the length. A display for presenting textual and graphical information to the user is usually present and visible when viewing a surface defined by the length and width of the instrument.

Another popular communication instrument is the hands-free headset (a type of hands-free device). This instrument enables the user of, for example, a cell phone to both speak and listen without having to hold the cell phone speaker adjacent to their ear. Instead, a speaker is mounted at one end of a boom in such a way that it is simply inserted into the ear or held in place by a clip over the outer ear or in some instances over the head. A microphone is mounted near the other end of the boom, with the boom being oriented so that the microphone is nearer though not necessarily adjacent to the user's mouth. The hands-free headset is typically not a cell phone in itself, but instead it communicates with a cell phone or other communication instrument using a short-range radio communication protocol such as Bluetooth®. The cell phone then provides the communication link to the wireless network.

In either case, and in others like them, the emphasis is in placing the speaker very close to the ear for easy hearing, and on making the instruments as small as conveniently possible for convenient carrying and handling. Unfortunately, this does work to the detriment of privacy in conversation and to some extent sound quality. As will now be described, the present invention may be used to enhance privacy for the user speaking in a conversation and at the same time possibly increasing the fidelity of the sound entering the instrument microphone and hence for the other party or parties to the communication. Note that in some implementations the level of fidelity enhancement for the listener may vary. On the one hand, some instruments and networks may be of poor quality that they are unable to take advantage of the improved sound at the microphone. On the other hand, the noise cancellation processing may be of such high quality that improved sound at the microphone is only a small gain. In either case, however, the improvement in sound fidelity, however small, is expected to be advantageous rather than detrimental. And in any event, no particular result is a requirement of the invention unless explicitly stated so in regard to a particular embodiment.

FIG. 1 is an isometric view of a privacy apparatus 100 used in conjunction with a mobile communication instrument according to an embodiment of the present invention. As can be seen in FIG. 1, this embodiment is most advantageously suited as an accessory to an instrument such as cell phone 190 having a relatively-flat profile. In this regard, however, it should be noted that the privacy apparatus of the present invention may be modified for use with communication devices having different dimensions as well. For reference, it is noted that cell phone 190 includes a display 192 and a trackball pointing device 196 for highlighting and selecting objects visible on display 192. Speaker openings 194 formed in housing 195 permit the passage of sound from an internal speaker (not shown). Cell phone 190 typically also includes a keypad, although this is not visible in FIG. 1. Also not visible is the microphone opening in housing 195, which in this embodiment is presumed to be at the bottom (not shown) of cell phone 190, the end or edge opposite the top 191.

In the embodiment of FIG. 1, privacy apparatus 100 has a first end 105 and a second end 115. A first opening 110 is formed in the first end 105 for receiving a communication instrument such as cell phone 190. A second opening 120 is formed in the second end 115 and is intended in use for placement at or near a sound source, presumably in most cases the mouth of a user of cell phone 190. First opening 110 and second opening 120 are in communication via an acoustic tunnel 101 formed through privacy apparatus 100.

As should be apparent from FIG. 1, the privacy apparatus 100, and hence the acoustic tunnel 101, includes a curved transition region 130. Curved transition region 130 reorients the acoustic tunnel 101 from a generally-downward direction to one that is generally-upward, although the reorientation will usually be somewhat less than 180°. In a preferred embodiment, the curved transition region 130 places the second opening 120 in the vicinity of the user's mouth when the speaker openings 194 of a cell phone 190 that has been received into first opening 110 are positioned near the user's ear. Note that the use of “downward” and “upward” correspond to the convention established above with respect to the top 191 and bottom of cell-phone 190. In actual use, of course, the user may orient the cell phone 190 and privacy apparatus 100 in almost any direction during a conversation.

In the embodiment of FIG. 1, the curved transition region 130 is accomplished by fabricating the privacy apparatus 100 in separate sections, which may then be assembled into the illustrated configuration. A first section 106 forms first opening 110, and is therefore preferably of a size to accommodate one or more popular cell phone models. A constraining device (not shown) may also be present to assist in retaining the cell phone when it has been received into first opening 110. This constraining device may be a resilient band, for example, or a drawstring. In other embodiments a portion of the acoustic tunnel 101 near the first opening 110 may be lined or partially-lined with a slip-resistant material, or a tab-and-notch system may be employed if compatible cell phones are available. For example, cell phone manufacturers may be encouraged to form notches on one or more faces of the instrument to accommodate a tab formed on the privacy apparatus 100. Or in other cases, the privacy device may simply be fabricated to take advantage of existing surface features of the communication instrument, such as photo-shutter button 197 or volume control 198 of cell phone 190. Note that as used herein, a “notch” may be a through-opening or depression formed in a structural component, and a “tab is simply a local protrusion from a planar surface, though either a notch or tab may in a given embodiment be specifically shaped to match with a particular corresponding feature.

In FIG. 1, the cell phone 190 is received into the first opening 110 only to the extent that the trackball pointing device 195 is still accessible. In another embodiment (not shown) an opening could be formed in the first section 106 of privacy apparatus 100 so that the cell phone could be further inserted and access to trackball 195 obtained through the opening. In yet another embodiment (also not shown) a keyboard opening could also be formed, permitting access to the keypad of cell phone 190. A clear window-pane, perhaps of a flexible plastic material, may in this case be extended across the keyboard opening to allow manipulation of the keys while still in effect enclosing them in the acoustic tunnel 101.

In the embodiment of FIG. 1, a second section 107 also forms a portion of privacy apparatus 100, forming an opening to receive a portion of first section 106 (and in use possibly a portion of cell phone 190 as well). From its circumference at the top opening where it communicates with first section 106, second section 107 tapers toward its bottom opening, narrowing the acoustic tunnel 101 and limiting the extent to which cell phone 109 travels along acoustic tunnel 101 when received through first opening 110. Note that the second section 107 is optional; alternatively, the first section 106 could simply be extended and, if desirable, tapered to similar effect.

In this embodiment, third section 108 of privacy device 109 communicates with second section 107 and fourth section 109. One end of third section 108 is received into a bottom opening of second section 107 and the opposite end into fourth section 109. As should be apparent, the communicating portions (not visible) of section 108 extend at an angle to accommodate the different orientations of second section 107 and fourth section 109, creating the curved transition region 130 of privacy apparatus 100.

The embodiment of FIG. 1 lends itself, for example, to construction of stiff paper or cardboard or similar material. This construction may be desired for the manufacture of relatively-inexpensive version of the privacy apparatus, for example to provide as a courtesy to airline passengers or restaurant patrons.

The construction joints shown in FIG. 1 are characteristics of the illustrated embodiment, however, and will not necessarily be present in other embodiments. In alternate embodiments, it may not be necessary to construct the privacy apparatus of separate sections fitted together. In other alternate embodiments the separate sections of the privacy apparatus are differently formed and assembled.

In another embodiment (not shown), the privacy apparatus 100 may simply be integrally-formed as a single unit, perhaps of a flexible plastic material. Even when so-formed, of course, a separate constraining device or other feature may be added. Another additional feature that may be present is a clip (not shown) for carrying the privacy device 100 by clipping it, for example to a belt, pocket, or waistband. If present, the clip is usually affixed to an exterior wall of the privacy device 100.

In another embodiment, the acoustic tunnel 101 is formed so as to receive the entire cell phone 190. In this manner the privacy apparatus 100 may function as a carrying case for the cell phone. In such an embodiment, of course, it is preferred that the privacy apparatus be constructed of a suitable material for this function (for example of a resilient plastic rather than paper). When used as a carrying case, the privacy device preferably utilizes a constraining device to secure the cell phone properly in the first opening 110 when in use. In addition, a strap or flap and fastener (not shown) may be used to retain the cell phone when fully enclosed if a constraining device is not present or usable for this function, or if additional security is desired.

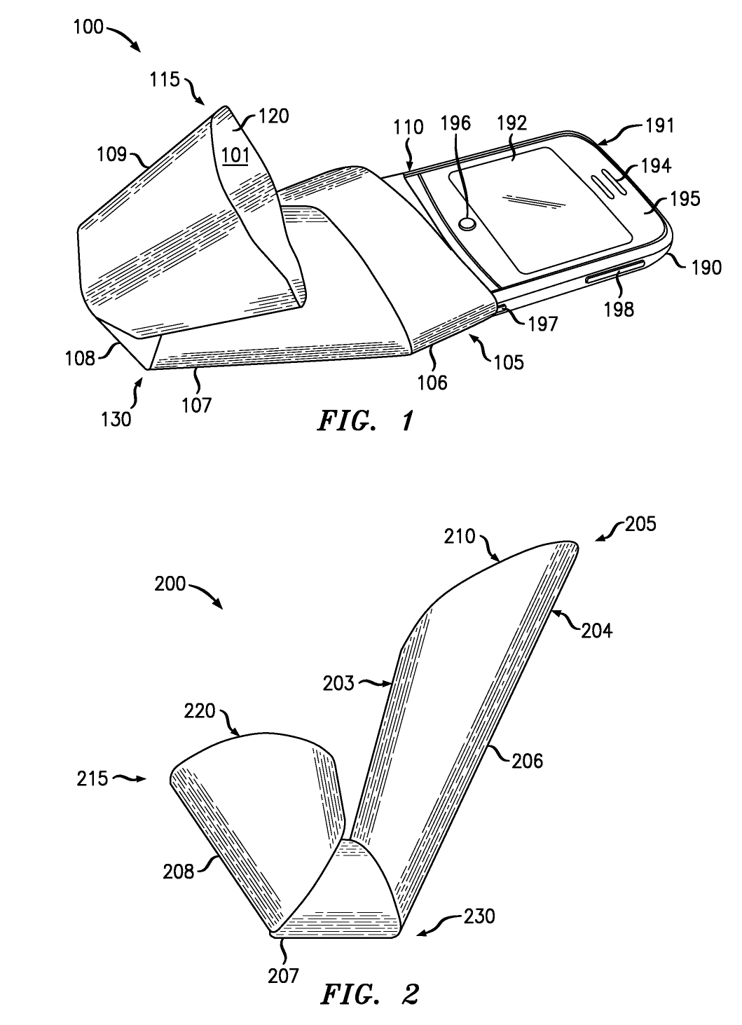

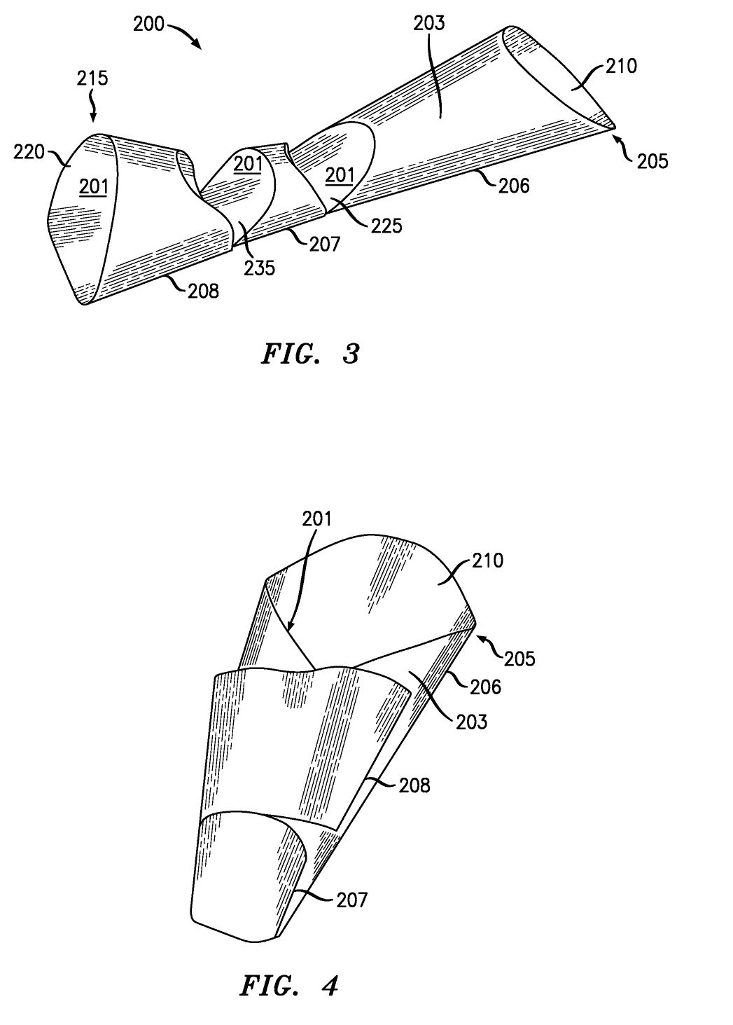

FIG. 2 is a side view of a privacy apparatus 200 according to another embodiment of the present invention. In this view it can be seen that privacy apparatus 200 includes three sections, a first section 206, a second section 207 and a third section 208. Not visible in FIG. 2 is the acoustic tunnel, which is formed through privacy apparatus 200 and extends from first opening 210 at the first end 205 to second opening 220 formed in the second end 215. A transition region 230 is formed primarily by the manner in which sections 206 through 208 fit together, as can also be seen in FIG. 3. The use of thee sections, however, is exemplary and not intended to be limiting.

The embodiment of FIG. 2 (and FIGS. 3-5 as well) is, for example, advantageously employed when the user is using a hands-free device such as the headset described above. In this implementation, it is usual that the small instrument is held in place by a clip placed over the outer ear or head of the user and does not have to otherwise be held in place during use of the privacy apparatus.

In this embodiment, the user orients the privacy apparatus 200 so that the second opening 220 is near the user's mouth, permitting the hands-free device presumably already in place to be received into the acoustic tunnel of privacy device 200 through the first opening 210.

In an alternate embodiment (not shown), a retaining clip is fixed to the privacy apparatus 200 itself, for example in the back 204 at or near the first end 205. The clip may be of the type that fits over the ear or over the head of the user, and assists in retaining the privacy apparatus 200 in place during use. In another alternate embodiment (also not shown), an opening is formed in the back 204 of the privacy apparatus 200 so that a clip of the hands free device may be inserted through the opening before being put into place. Naturally, in this case it is preferred that the privacy apparatus 200 be formed of a relatively-lightweight material. In yet another embodiment (not shown), a notch could be formed in the back 204 of privacy apparatus 200 such that, for example, the in-ear (or some other) portion of the hands free device is exposed, allowing access for manipulation of the device or controls located thereon if desired. As should be apparent, as with the privacy device 100 of FIG. 1, the privacy device 200 may be designed to accommodate such different models of hands free devices, however, positioned, as are currently available.

In this regard, it is noted that in any embodiment, when being designed for a particular communication instrument the expected location of the instrument's microphone may be accommodated. For example, in the privacy device 100 of FIG. 1, if the microphone opening of cell phone 190 is located on the front of the device (as are the display 192 and keyboard), then first section 106 may be shaped to ensure that the microphone opening will be properly located in the acoustic tunnel 101, perhaps providing for local separation from the cell phone at that location.

FIG. 3 is an isometric view of the privacy apparatus 200 of FIG. 2 shown in an extended configuration to illustrate its construction. As can be seen in FIG. 3, in this embodiment section 206 through 208 are integrally-formed. A semi-circumferential portion has been (at least figuratively) removed from between section 206 and section 207, however, to form a third opening 225. Third opening 225, as can be seen in FIG. 3, is wider at the front 203 of privacy apparatus 200, and narrows as it progresses toward the back 204, which in this embodiment is left intact. Similarly, fourth opening 235 is formed between sections 207 and 208. As should be apparent, for use the sections 206 and 208 are folded toward each other to close the openings 225 and 235, creating transition region 230, and forming the configuration shown in FIG. 2. As the extended configuration of FIG. 3 is not required in normal operation, the sections may be fixed together, for example by using an adhesive.

Note, however, that as with privacy apparatus 100, other fabrication techniques may be used to create privacy apparatus 200, for example so that the transition region 230 is formed of a continuously-molded material that cannot without cutting actually extend to the configuration shown in FIG. 3.

In any embodiment, a stiffening element (not shown) may be added. The stiffening element may be, for example, a wire or thin metal member that can be subjected to plastic deformation. For example, in the embodiment of FIG. 3, such an element could be attached to the interior or exterior wall of back 204 so that when folded into a configuration for use, the stiffening element would assist in maintaining the privacy apparatus 200 in that configuration. The stiffening element may run the entire length of the privacy apparatus 200, or only a portion thereof. It could be continuous or segmented along its length, and of course a plurality of stiffening elements may be used. As should be apparent, the stiffening element, if used, could also be place in other areas, for example along the front 203 of the privacy accessory 200. In addition, stiffening elements may be used in other ways, for example circumferentially about second opening 120 of FIG. 1 or 220 of FIG. 2 to maintain a desired but alterable opening shape for the respective privacy apparatus. A stiffening element may also form the constraining element mentioned above, or a component thereof, for securing in place a cell phone in the embodiment of FIG. 1.

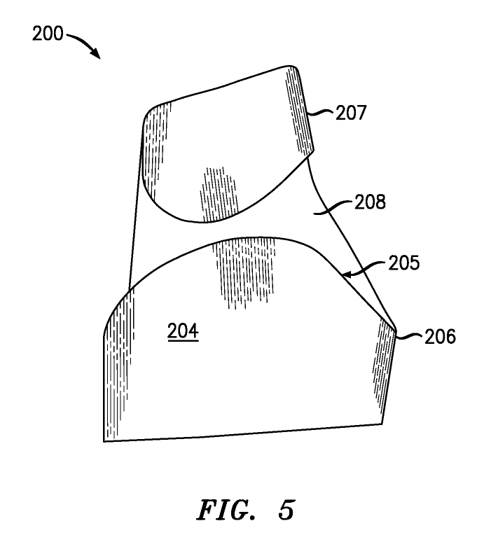

In most embodiments, it is preferred that the privacy apparatus 100 be collapsible for convenient carrying. That is, when not in use the acoustic tunnel collapses so that the privacy apparatus folds into a flat profile. FIGS. 4 and 5 illustrate this feature.

FIG. 4 is an isometric view of the privacy apparatus 200 of FIG. 2 in a collapsed configuration. In this view, it can be seen that the privacy apparatus 200 has been collapsed by bringing front 203 toward back 204 and folding sections 207 and 208 toward section 206 about an axis defined along back 204 by opening 225. In this relatively-flat configuration, the privacy apparatus may be conveniently carried in a holster or pocket, perhaps along with the hands free instrument that it is used with. In some cases, the hands free device may simply be placed in the acoustic tunnel 201, where it will somewhat prevent the full collapse into a flat profile, but be protected by the privacy device 200 while being stored.

FIG. 5 is an isometric view of the privacy apparatus 100 of FIG. 1 in a collapsed configuration. Here, starting with configuration illustrated in FIG. 4, first end 205 is folded along an axis defined by the front 203 and back 204 where they have been brought together at about the second end 215. Here it is noted that the descriptions of folding privacy apparatus 200 are geometrically approximate and intended for illustration. The main advantage of this embodiment is of course the collapsible feature of the privacy apparatus, and other folding methodologies may be used to similar advantage.

Note that in the embodiment of FIG. 5, a fastening device (not shown), such as a snap or button and slot may be employed near first end 205 in order to secure it in place when folded. This may be of particular advantage when the hands free instrument is stored in acoustic tunnel 201, although it may also be used simply to retain the privacy apparatus in a collapsed state. As should be apparent, the use of one or more stiffening members may also assist in retaining a folded configuration.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An accessory for a mobile communication instrument, comprising:
an acoustic tunnel forming a first opening at a first end and a second opening at a second end, the first opening for receiving at least a portion of the communication instrument and the second opening for placing in the vicinity of a sound source.

2. The accessory of claim 1, wherein the acoustic tunnel comprises a series of acoustic sub-tunnels configurable to form the acoustic tunnel.

3. The accessory of claim 1, wherein the acoustic tunnel is adjustable in shape.

4. The accessory of claim 3, wherein the acoustic tunnel collapses to a relatively-flat shape for storage when not in use.

5. The accessory of claim 3, further comprising a constraining element for retaining the communication instrument in a desired position.

6. The accessory of claim 5, wherein the constraining element is a resilient band.

7. The accessory of claim 1, further comprising at least one stiffening element.

8. The accessory of claim 7, wherein the at least one stiffening element comprises a plurality of wires.

9. The accessory of claim 7, wherein the at least one stiffening element is circumferentially mounted at the second end for maintaining a desired shape of the second opening.

10. The accessory of claim 1, wherein the accessory is adapted to receive the communication instrument fully into acoustic tunnel for use as a carrying case.

11. The accessory of claim 10, wherein the accessory further comprises a clip for attaching the accessory to a user's clothing when used as a carrying case.

12. The accessory of claim 10, further comprising a fastener for securing the communication instrument.
